(19) United States
(12) Patent Application Publication
(10) Pub. No.: US 2004/0109225 A1
(43) Pub. Date: Jun. 10, 2004

(54) Multi-mode pumped ase source using phosphate and tellurite glasses

(75) Inventors: Yongdan Hu, Tucson, AZ (US); Sergio Brito Mendes, Tucson, AZ (US); Shibin Jiang, Tucson, AZ (US); Sandrine Hocde, Tucson, AZ (US); Yushi Kaneda, Tucson, AZ (US)

Correspondence Address: NP PHOTONICS, INC., 9030 SOUTH RITA ROAD, SUITE 120, TUCSON, AZ, 85747, US

(73) Assignee: NP Photonics, Inc.

(21) Appl. No.: 10/313,287

(22) Filed: Dec. 6, 2002

(51) Int. Cl. H01S 3/00

(52) U.S. Cl. 359/341.1

(57) ABSTRACT

A compact, high-power, low-cost broadband ASE source is achieved by multi-mode pumping a highly doped multi-component glass fiber in standard ASE source configurations. The multi-mode pump is coupled into and propagates in the fiber cladding exciting the rare-earth dopant ions (Er,Yb) in the fiber core. The multi-component glass includes a network former selected from either phosphate (P₂O₅) or tellurite (TeO₂) and is doped with at least 0.25 weight percent rare-earth dopants. The high concentrations of dopants supported by these glasses absorbs the multi-mode pump in a short length, less than 100 cm, and provides high saturated output powers.

### CROSS-REFERENCE TO RELATED APPLICATIONS

This application claims benefit of priority under 35 U.S.C. 120 to U.S. applications Ser. No. 09/589,764 entitled “Erbium and Ytterbium Co-Doped Phosphate Glass Optical Fiber Amplifiers Using Short Active Fiber Length” filed on Jun. 9, 2000 and Ser. No. 09/943,257 entitled “Total Internal Reflection (TIR) Coupler and Method for Side-Coupling Pump Light into a Fiber”, filed Aug. 30, 2001, the entire contents of which are incorporated by reference.

### BACKGROUND OF THE INVENTION

1. Field of the Invention

This invention relates to fiber amplified spontaneous emission (ASE) light sources and more specifically to multi-mode pumped ASE sources using phosphate and telluride glasses

2. Description of the Related Art

Fiber ASE light sources are well known in the art. ASE sources have been advantageously used to provide wideband (e.g., on the order of 10 to 30 nanometers), single spatial mode light beams for multiple applications. For example, ASE sources have been used to provide laser light as an input to a fiberoptic gyroscope. For a description of an exemplary superfluorescent fiber source, see an article entitled “Amplification of Spontaneous Emission in Erbium-Doped Single-Mode Fibers” by Emmanuel Desurvire and J. R. Simpson, published by IEEE, in “Journal of Lightwave Technology,” Vol. 7, No. 5, May 1989 and “Characteristics of Erbium-Doped Superfluorescent Fiber Sources for Interferometric Sensor Applications” by Paul Wysock et al, in “Journal of Lightwave Technology,” Vol. 12., No. 3, March 1994, pp. 550-567.

An ASE light source typically comprises a length of single-mode silica fiber, typically 1-50 m, with a core doped with an ionic, trivalent rare-earth element. For example, neodymium (Nd³⁺) and erbium (Er³⁺) are rare-earth elements that may be used to dope the core of a single-mode fiber so that the core acts as a laser medium. Typical Er³⁺ doping concentrations are 0.02-0.2 weight percent.

The fiber receives a pump input at one end. The pump is typically a laser having a specific wavelength λₚ. The ions within the fiber core absorb the input laser radiation at wavelength λp so that electrons in the outer shells of these ions are excited to a higher energy state of the ions. When a sufficient pump power is input into the end of the fiber, a population inversion is created (i.e., more electrons within the ions are in the excited state than are in the ground state), and a significant amount of fluorescence is caused along the length of the fiber. As is well known, the fluorescence (i.e., the emission of photons at a different wavelength λₛ) is due to the spontaneous return of electrons from the excited state to the ground state so that a photon of a wavelength λₛ is emitted during the transition from the excited state to the ground state. The light which is emitted at the wavelength from the fiber is highly directional light, as in conventional laser light. However, one main characteristic of this emission which makes it different from that of a traditional laser (i.e., one which incorporates an optical resonator) is that the spectral content of the light emitted from the superfluorescent fiber source is generally very broad (between 10 and 30 nanometers). Thus the optical signal output by the fiber will typically be at a wavelength λₛ±15 nanometers. This principle is well known in laser physics, and has been studied experimentally and theoretically in neodymium-doped and erbium-doped fibers, and in fibers doped with other rare-earths, for several years.

Light emitted from ASE fiber sources has multiple applications. For example, in one application, the output of the ASE source is fed into a fiberoptic gyroscope. For reasons that are well understood by those skilled in the art, the fiberoptic gyroscope should be operated with a broadband source that is highly stable. Of the several types of broadband sources known to exist, superfluorescent fiber sources, in particular, made with erbium-doped fiber, have thus far been the only optical sources that meet the stringent requirements for inertial navigation grade fiberoptic gyroscopes. The broad bandwidth of light produced by erbium-doped fiber sources, together with the low pump power requirements and excellent wavelength stability of erbium-doped fiber sources, are the primary reasons for use of such sources with fiberoptic gyroscopes.

In an erbium-doped fiber, the emission of a superfluorescent fiber source is bi-direction. That is, the amplified light which is emitted by the return of electrons to the ground state in the erbium ions is typically emitted out of both ends of the fiber. As described in U.S. Pat. No. 5,185,749 to Kalman, et al., for erbium fibers of sufficient length, the light propagated in the backwards direction (i.e., in the direction opposite that in which the pump signal propagates), has a very high quantum efficiency. Thus, it is advantageous to implement erbium sources so that the light emitted from the ASE erbium-doped source is emitted from the pump input end of the fiber (i.e., in the backward propagation direction).

An ASE source is typically implemented in one of two general configurations. In a first configuration, called a single-pass backward-signal ASE source, the superfluorescent source output power is emitted in two directions, one of which is not used. The unwanted forward ASE is attenuated by first making the silica fiber much longer, e.g. 100 m. The last tens of meters are not pumped and thus function as an attenuator. Second, the end of the fiber is angle cleaved to prevent instability due to reflection. The backward ASE propagates through the fiber where it is emitted from the source.

In the second configuration, called a double-pass backward-signal ASE source, a reflector is placed at one end of the fiber to reflect the superfluorescent source signal so that the superfluorescent signal is sent a second time through the fiber. Since the fiber exhibits gain at the signal wavelength, the signal is amplified. One advantage of the double-pass configuration is that it produces a stronger signal. Another advantage is that it requires only about 30 m of erbium-doped silica fiber. A double-pass ASE source configuration also produces output only at one port (i.e., in one direction). A disadvantage with such a configuration is that the feedback must be kept very low in order to prevent lasing. It is well known in the art that the base single and double-pass configurations may be modified to accommodate other factors. For example, in a variation on the single-pass design, known as the fiber amplifier source (FAS), the doped fiber acts not only as a backward-signal source, but also as an amplifier for a returning signal.

Commercially available ASE sources uses tens of meters of doped silica fiber. Spooling this length of silica fiber affects the size, complexity and cost of the ASE source. A silica glass host also limits the bandwidth of the emission spectra. The industry has a demonstrated need for a compact, high-power, low-cost broadband ASE source.

### SUMMARY OF THE INVENTION

The present invention provides a compact, high-power, low-cost broadband ASE source.

This is accomplished by multi-mode pumping a highly doped multi-component glass fiber in standard ASE source configurations. The multi-mode pump is coupled into and propagates in the fiber cladding exciting the rare-earth dopant ions (Er, Yb) in the fiber core. The multi-component glass includes a network former selected from either phosphate or tellurite and is doped with at least 0.25 weight percent rare-earth dopants. The high concentrations of dopants supported by these glasses absorbs the multi-mode pump in a short length, less than 100 cm, and provides high saturated output powers. Absorption efficiency is further enhanced with a multi-clad fiber that focuses the pump into the fiber core. The short fiber lengths also provide a more compact device that is easier to temperature stabilize and cheaper to manufacture. Shared pump arrayed ASE sources are enabled with this technology.

In one embodiment, the ASE source utilizes a subclass of phosphate glasses that comprises a phosphate (P₂O₅) network former of 50 to 70 mole percent; a network modifier MO of 0 to 25 weight percent (BaO, BeO, MgO, SrO, CaO, ZnO, PbO and mixtures thereof) a network intermediator A₂O₃ of 2 to 20 weight percent (WO₃, Y₂O₃, La₂O₃, Al₂O₃, B₂O₃ and mixtures thereof); and co-doped with erbium 1.5 to 5 weight percent and ytterbium 0 to 12 weight percent.

In a second embodiment, the ASE source utilizes a subclass of tellurite glasses that comprise a tellurite (TeO₂) from 50 to 70 mole percent, A₂O₃ from 10 to 40 mole percent including B₂O₃ from 5 to 22 mole percent (Al₂O₃, Y₂O₃, B₂O₃ and mixtures thereof), a glass network modifier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), Ge0₂ from 0 to 7 mole percent and rare-earth dopant L₂O₃ from 0.25 to 10 weight percent (Er₂O₃, Yb₂O₃ and mixtures thereof).

In a third embodiment, a multi-mode pump is shared to pump an array of doped multi-component glass waveguides.

In a fourth embodiment, sections of phosphate and tellurite Er-doped fiber are multi-mode pumped to produce a composite ASE source that is high power and broadband.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a multi-mode pumped Er-doped multi-component glass fiber ASE source in accordance with the present invention;

FIG. 2 is a sectional view of a TIR pump coupler mounted on passive double-cladding fiber and the double-clad multi-component glass fiber illustrating the propagation of the multi-mode pump through the fiber;

FIGS. 3a and 3b is a sectional view of a multi-clad fiber and a plot of pump absorption as a function of cladding layers to illustrate a focusing effect;

FIG. 4 is a prospective view of an arrayed ASE source;

FIG. 5 is an energy level diagram of an Er:Yb codoped multicomponent glass;

FIGS. 6a and 6b are plots of absorption and emission cross sections for Er³⁺-doped tellurite, phosphate and silica glasses;

FIG. 7 is a table of an Er-doped multi-component glass compositions;

FIGS. 8 is a table of an Er-doped phosphate glass composition;

FIGS. 9 is a table of an Er-doped tellurite glass composition and its emission spectra; and

FIGS. 10a and 10b are an ASE Source with sections of phosphate and tellurite glass fibers and the composite emission spectra.

### DETAILED DESCRIPTION OF THE INVENTION

The present invention provides a compact, high-power, low-cost broadband ASE source. This is accomplished by multi-mode pumping a highly doped multi-component glass fiber in standard ASE source configurations. Without loss of generality, the invention will be described in the context of a single-pass backward-signal ASE source.

ASE Source

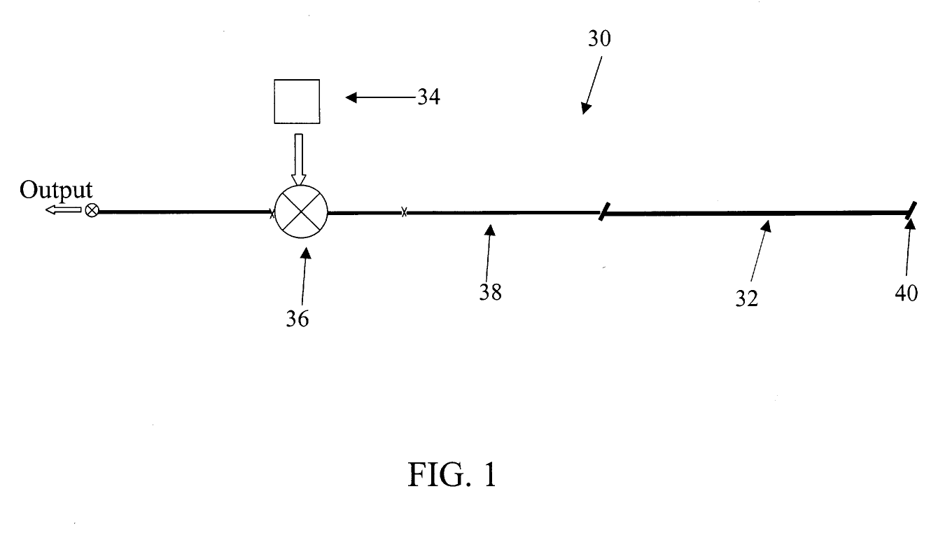

As shown in FIG. 1, a single-pass backward-signal ASE source 30 includes a length of multi-clad fiber 32 formed from a highly doped multi-component glass, a multi-mode pump source 34, suitably a multimode semiconductor diode laser, and pump coupler 36, and a length of single-mode fiber (SMF) 38. The multimode pump is coupled into and propagates in the fiber cladding where it is absorbed by and excites the rare-earth dopant ions in the fiber core to produce stimulated emission. The superfluorescent source output power is emitted in two directions, one of which is not used. The unwanted forward ASE is attenuated by first making the multi-component glass fiber slightly longer, e.g. 30 cm. The last few centimeters are not efficiently pumped and thus function as an attenuator. The end 40 of the fiber is angle cleaved to further attenuate the forward ASE. The backward ASE propagates through SMF 38 where it is emitted from the source. A double-pass ASE source would be very similar except a reflector would be formed at end 40 and the fiber length would be somewhat shorter, e.g. 20 cm, to avoid attenuation of the forward ASE.

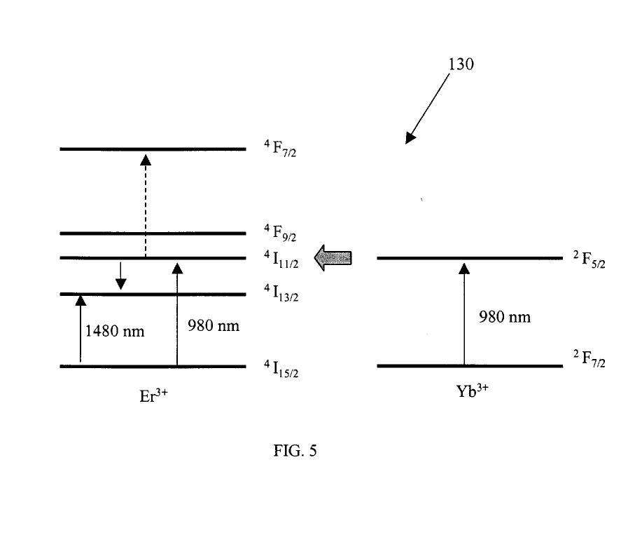

As will be described in detail with reference to FIGS. 5-9, the multi-component glasses of interest have a glass composition that contains 50-70 mol percent glass network former of phosphate (P₂O₅) or tellurite (TeO₂), 0-25 mol percent network modifier MO (BaO, BeO, MgO, SrO, CaO, ZnO, PbO and mixtures thereof), 0-25 mole percent network modifier R₂O (Li₂O, Na₂O, K₂O, Rb₂O and mixtures thereof), and 0-40 mole percent glass network intermediator A₂O₃ (WO₃, Y₂O₃, La₂O₃, Al₂O₃, B₂O₃ and mixtures thereof). The tellurite glass may also include 0-7 mol percent GeO₂. The phosphate and tellurite glass hosts are characterized by wider absorption, hence emission cross sections than silica which allow them to have broader emission spectra.

Furthermore, the high solubility of the multi-component glass host material allows the fiber core to be doped with high concentrations (0.25-20 wt %) of rare-earth dopants such as erbium and ytterbium and mixtures thereof. A high concentration of doping ions provides a high gain-per-unit length, which makes possible short and compact devices. A few tens of centimeters of highly doped fiber in combination with higher power multimode pumps can provide output power of the same level as in conventional ASE sources using several tens of meters. By optimizing the glass host material and the doping ions (species and concentration), as well as the fiber length, the emission spectrum, and therefore the ASE spectrum, can be controlled. Note, the glass network former, modifier and other elements are typically specified in mole % because the glass structure is related with the mole% of every element in the glass. The dopants are typically specified in weight % because the doping concentration in term of ions per volume, e.g., ions per cubic centimeters, can be readily derived and is critical information for photonic and optical related applications.

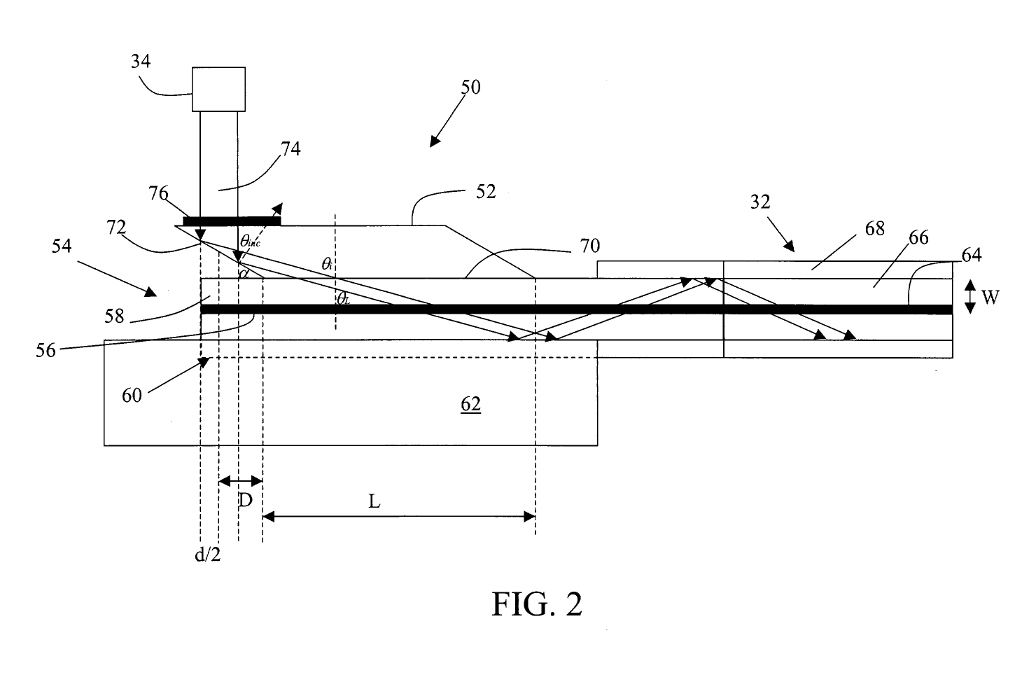

The function of the pump coupler is to efficiently couple the multimode pump into the cladding of fiber 32 where the pump excites the ionic rare-earth dopants in the core of the fiber to produce emission. Pump coupler 36 may be a WDM, a side-coupler such as Goldberg's V-groove as described in U.S. Pat. No. 5,854,865 or, as illustrated in FIG. 2, a total internal reflection (TIR) coupler as described in co-pending U.S. patent application Ser. No. 09/943,257 entitled “Total Internal Reflection (TIR) Coupler and Method for Side-Coupling Pump Light into a Fiber”, which is hereby incorporated by reference. Other techniques may also be used to couple the pump into the doped fiber.

As shown in FIG. 2, a TIR coupler 50 includes a TIR prism 52 mounted on passive double-clad fiber 54, which is optically coupled between multi-clad active fiber 32 and SMF 38. Double-clad fiber 54 comprises an undoped core 56, an inner cladding 58 and a partial outer cladding 60 and is mounted on a substrate 62. Active fiber 32 comprises a doped core 64, at least one inner cladding 66 and an outer cladding 68 and is connected to double-clad fiber 54. TIR prism 52 is bonded in optical contact to a flat surface 70 on the passive fiber's inner cladding 58 for length L. The pump directs light into the TIR prism from either the front or backside (not shown) of the fiber, which is mounted on a substrate, and is preferably oriented substantially normal to the fiber to simplify packaging, facilitate the use of a multi-mode pump and simplify the design of any anti-reflection (AR) coatings.

The TIR coupler has an angle of taper α and a length L such that the principal ray of the pump light is reflected at an angle that satisfies the total internal reflection (TIR) condition at the coupler's reflecting surface, and input and output coupling conditions, to efficiently “fold” the light into the fiber and satisfies the TIR condition inside the fiber to “guide” the light down the fiber's inner cladding. The angle of incidence is preferably such that substantially all of the pump light (principal and marginal rays) satisfies the TIR condition. The pump light is preferably focused to obtain such high coupling efficiencies and to confine the light within a narrow cladding, which produces higher power density.

TIR prism 52 has a reflecting surface 72 that forms an exterior angle of taper α with respect to surface 70. In this example, and as will typically be the case, the cores and inner claddings of the passive and active fibers are substantially matched in both refractive index and cross-section. Pump source 34 is positioned on the front side of substrate 62 so that a beam of pump light 74 having finite width d is substantially normal to the fiber. Pump light 74 passes through AR coating 76, reflects off surface 72 and is folded into passive fiber 54, which in turn guides the pump light into active fiber 32 thereby exciting the entire length of doped core 64 in the active fiber. Assuming a substantially collimated beam and index-matched fibers, the constraint equations for the passive coupler shown in FIG. 5b are given by:

$$\begin{matrix}\frac{π - {θ}_{i}}{2} > arcsin ( \frac{1}{{n}_{coupler}} ) & ( 1 ) \\ {θ}_{L} > arcsin ( \frac{{n}_{ext}}{{n}_{clad}} ) & ( 2 ) \\ \frac{( \vert D \vert + d / 2 )}{cos {θ}_{i}} < L < \frac{( \vert D \vert - d / 2 )}{cos {θ}_{i}} + 2 W tan {θ}_{L} & ( 3 )\end{matrix}$$

dₘₐₓ=2W tan θ_{L} cos θᵢ (4)

where

n_{coupler} is the refractive index of the coupler and the surrounding media is air;

n_{clad} is the refractive index of the fibers' inner cladding,

nₑₓₜ is the refractive index of the active fiber's outer cladding;

W is the diameter of the active fiber's inner cladding;

|D| is the lateral distance from the starting point of the taper to the point where the beam of pump light strikes the reflecting surface as projected onto the fiber where |●| is the absolute value operation;

dₘₐₓ is the maximum beam diameter for d;

θᵢ is the angle of incidence at the coupler-fiber interface and is dictated by the geometry of the taper and the angle of incidence θ_{inc} at the air-coupler interface;

θ_{inc} is the angle of incidence of the pump light with respect to the reflecting surface, e.g. the angle measured from the normal to the reflecting surface to principal ray of the incident light, θ_{inc} is equal to (π−θᵢ)/2 for a pump source that is oriented normal to the fiber; and

θ_{L} is the launch angle of the pump light into the fiber, which in many cases where the coupler and inner cladding are index matched, the launch and incidence angles at the coupler-fiber interface are the same.

As shown in FIG. 2 and just described, the multi-mode pump source and pump coupler are effective to produce and efficiently couple a relatively large amount of optical power into the active fiber's inner cladding. In a typical double-clad fiber, the pump is confined inside the inner cladding as it propagates down the fiber and is absorbed by the core.

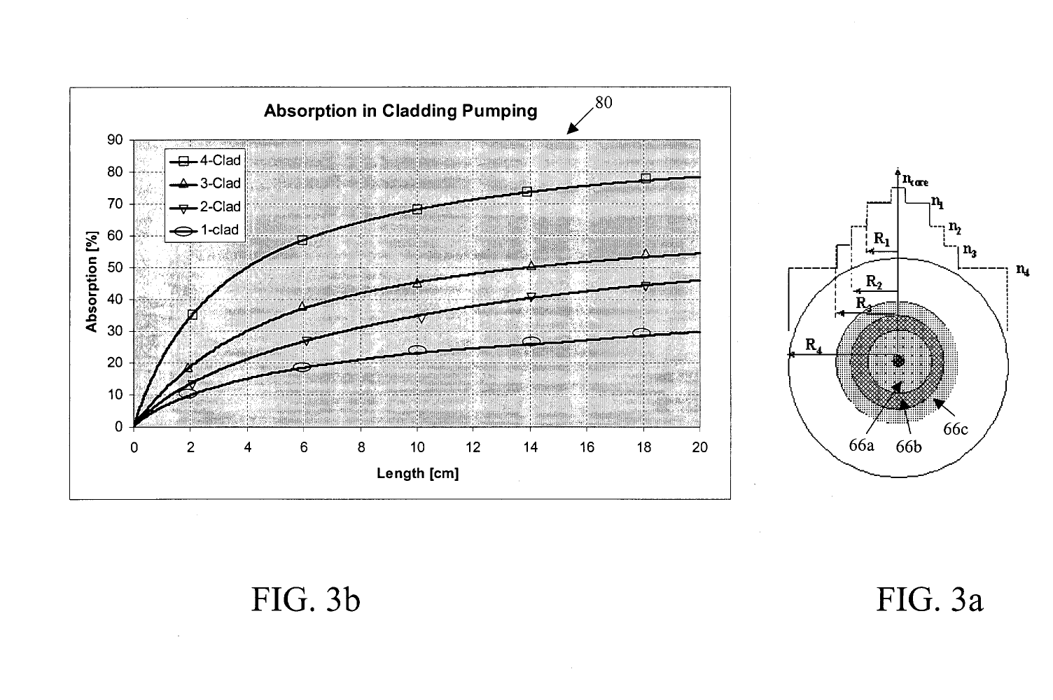

As shown in FIGS. 3a and 3b, the rate of absorption can be increased by using two or more inner cladding layers 66a, 66b, and 66c to focus the pump into the core 64 using a lensing effect. A plot 80 of absorption percentage versus length for a number of cladding layers shows a dramatic increase due to the lensing effect. In the multi-clad fiber as shown in FIG. 3a, n_{core}>n₁>n₂>n₃>n₄ and Rᵢ are optimized to achieve appropriate absorption characteristics along with optimization of nᵢ.

Arrayed ASE Source

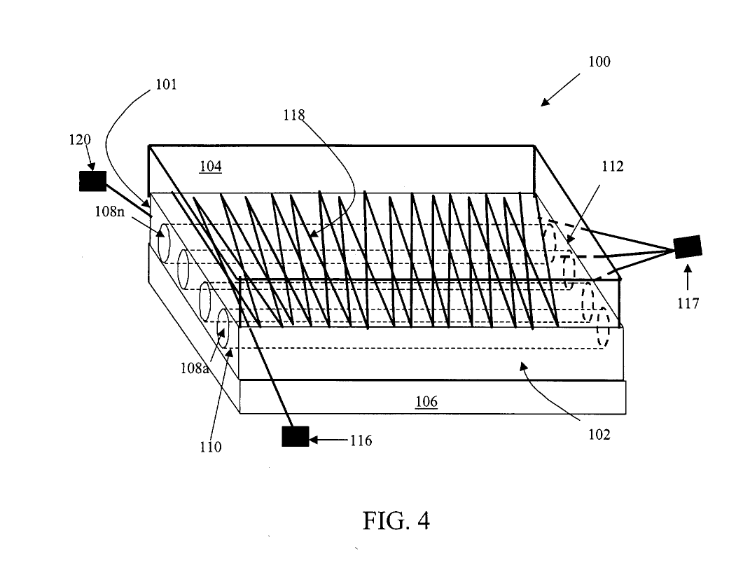

The multi-mode pumped multi-component glass fiber architecture is also particularly well suited for an array configuration in which a single pump source is shared to produce multiple independent ASE sources. As shown in FIG. 4, an arrayed ASE source 100 is particularly promising because the pump(s) can be shared efficiently and the waveguides' short length works well with the side pumping geometry. Waveguide array 101 has an inner cladding layer 102 sandwiched between a pair of outer cladding layers 104 and 106, which together confine and guide the pump light within the inner cladding. A plurality of active core elements 108a-108n are arranged longitudinally in inner cladding layer 102 to define optical signal paths between respective pairs of output facets 110 and end facets 112. The inner cladding layer and each of the active core elements confine respective optical ASE source signals inside the active core elements as they travel the optical signal paths. The surface of the output facets is substantially transmissive over a broadband to output couple the ASE source signals. The waveguide array can be constructed by placing a number of DC active fibers in an inner cladding medium sandwiched between a pair of outer clad substrates, by pulling the waveguide array as if it were a fiber or using standard waveguide processing.

In a single-pass backward accumulation configuration, a pump laser 116 can be positioned to the side of the waveguide array towards the output facet 110 and oriented such that pump beam 118 traverses the waveguide and zig-zags back-and-forth as the pump travels longitudinally down the waveguides. The pump light which passes through or around the first active core element intercepts the second active core element, and so on. Both side and top and bottom surfaces of the waveguide array are coated with a material suitable for reflecting the pump. The pump weakens toward the end facets 112 so that the doped cores act as absorbers to attenuate forward ASE. The end facets can also be angle polished or coated to reduce forward ASE reflection. Alternately, a pump laser 117 can also be used to end-pump the ASE array. In this case, facet 112 is transmissive for the pump and reflective for ASE.

In a double-pass configuration, a second pump laser 120 (in addition to pump 116) may be positioned on the other side of the array towards the end facets so that its pump beam transverses the waveguide and zig-zags back-and-forth as the pump travels longitudinally down the waveguides. The second pump ensures that the entire length of each core is inverted. The end facets 112 are substantially perpendicular to the optical paths and preferably coated with a broadband material to reflect the forward ASE. The waveguide array is particularly well suited for the double-pass configuration.

Phosphate and Tellurite Multi-Component Glasses

To achieve high-gain in ultra-short lengths, e.g. 10-100 cm, the glass host must support very high Er doping concentrations to realize the necessary gain, support very high Yb doping concentration to efficiently absorb pump light in an ultra-short distance, and transfer energy efficiently from the absorbed ytterbium to the erbium. Compared to either silica or phosphosilicate, a multi-component glass host improves the solubility to erbium and ytterbium ions thereby allowing higher dopant levels without raising the upconversion rate and increases the phonon energy thereby reducing the lifetime of ions in the upper energy state which has the effect of improving energy transfer efficiency. Multi-component glasses support doping concentrations of the rare-earth ions erbium and ytterbium far in excess of levels possible with conventional glasses. The nonradiative transition between level I_{11/2} to the level I_{13/2} is very fast due to the higher phonon energy compared with silica glass. Fast transfer from the level I_{11/2} to the level I_{13/2} prevents back transfer. As a result, codoping with ytterbium has a significant effect on the absorption of multicomponent glass fiber.

The energy level diagram 130 of an Er:Yb codoped multi-component glass such as phosphate or tellurite is shown in FIG. 5. To produce laser emission pump light excites electrons from the ground state ⁴I_{15/2} to an upper energy state such as ⁴I_{11/2}. Higher erbium doping levels allows more absorption of the pump light and ultimately higher gain and higher output power levels. Once electrons are excited to the ⁴I_{11/2} state, relaxation occurs through phonon processes in which the electrons relax to the ⁴I_{13/2} state, giving up energy as phonons to the glass host material. The state ⁴I_{11/2} is a metastable state, which normally does not readily emit a photon and decay to the ground state (i.e., the ⁴I_{15/2} state).

Co-doping with ytterbium enhances population of the erbium 4I_{11/2} metastable state. The Yb³⁺ excited states 2F_{5/2} are pumped from the Yb^{3+ 2}F_{7/2} ground state with the same pump wavelength that is used to excite upward transitions from the erbium ground state ⁴I_{15/2}. Energy levels of the excited ytterbium ²F_{5/2} state coincide with energy levels of the erbium 4I_{11/2} state permitting energy transfer (i.e. electron transfer) from the pumped ytterbium ²F_{5/2} state to the erbium ⁴I_{11/2} state. Thus, pumping ytterbium ionic energy states provides a mechanism for populating the metastable erbium ⁴I_{11/2} state, which relaxes to the erbium ⁴I13/2 and permitting even higher levels of population inversion and more stimulated emission than with erbium doping alone.

Ytterbium ions exhibit not only a large absorption cross-section but also a broad absorption band between 900 and 1100 nm. Furthermore, the large spectral overlap between Yb³⁺ emission (²F_{7/2}−²F_{5/2}) and Er³⁺ absorption (⁴I_{15/2}−⁴I_{11/2}) results in an efficient resonant energy transfer from the Yb^{3+ 2}F_{5/2} state to the Er^{3+ 4}I_{11/2} state. The energy transfer mechanism in an Yb³⁺/Er³⁺ co-doped system is similar to that for cooperative upconversion processes in an Er³⁺ doped system. However, interactions are between Yb³⁺ (donor) and Er³⁺ (acceptor) ions instead of between two excited Er³⁺ ions.

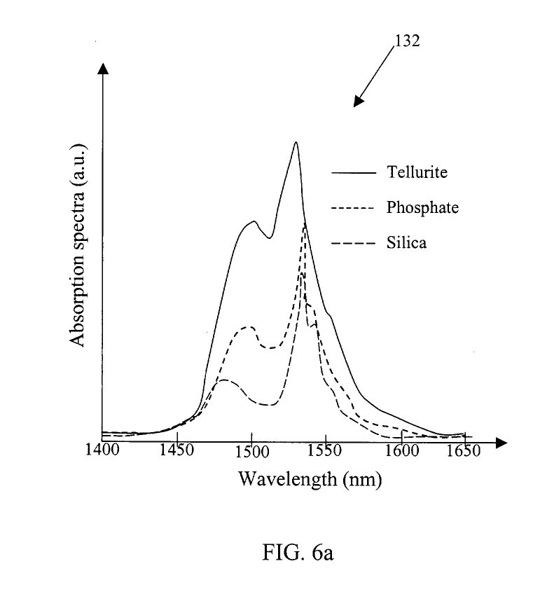

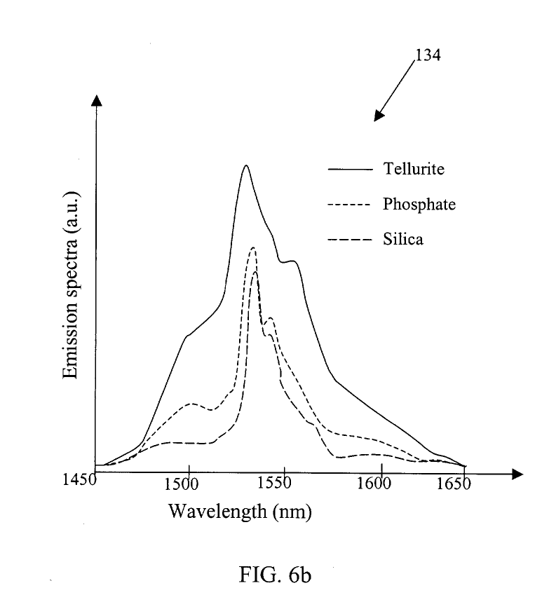

FIGS. 6a and 6b are plots of absorption 132 and emission 134 spectra for Er³⁺-doped tellurite, phosphate and silica glasses. The absorption and emission spectra of phosphate and particularly tellurite are significantly larger than those of silica glass.

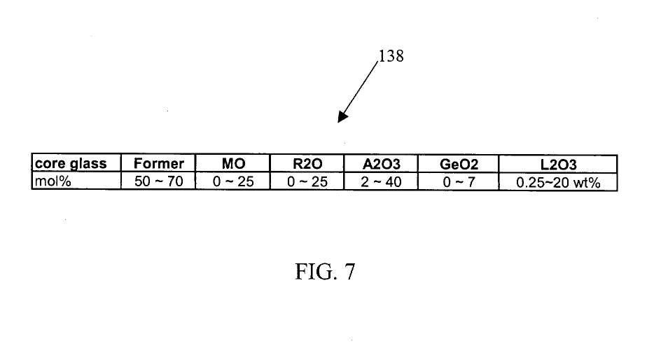

As shown in FIG. 7, the multi-component glasses 138 of interest have a glass composition that contains 50-70 mol percent glass network former of phosphate (P₂O₅) or tellurite (TeO₂), 0-25 mol percent network modifier MO (BaO, BeO, MgO, SrO, CaO, ZnO, PbO and mixtures thereof), 0-25 mole percent network modifier R₂O (Li₂O, Na₂O, K₂O, Rb₂O and mixtures thereof), and 0-40 mole percent glass network intermediator A₂O₃ (WO₃, Y₂O₃, La₂O₃, Al₂O₃, B₂O₃ and mixtures thereof). The glass network formers are selected because their glass networks are characterized by a substantial amount of non-bridging oxygen that offers a great number of dopant sites for rare-earth ions. The modifiers modify the glass network, thereby reducing its melting temperature and creating additional dopant sites. The intermediator bridges some of the bonds in the network thereby increasing the network's strength and chemical durability without raising the melting temperature appreciably. The multi-component glasses of interest thus have a much lower softening temperature than silica (SiO₂), which greatly simplifies processing. The tellurite glass may also include 0-7 mol percent GeO₂ to increase the glass transition temperature, thermal stability and refractive index. The high solubility of the multi-component glass host material allows the fiber core to be doped with high concentrations (0.25-20 wt %) of rare-earth dopants such as erbium and ytterbium or mixture thereof.

Er-Doped Phosphate Glasses

Phosphate glass compositions are particularly effective to provide high power ASE sources that produce a broadband signal in the C and L bands. Using a 1 W multi-mode pump source and 10-50 cm of doped-phosphate fiber, output power levels of >13 dBm are expected over a bandwidth of 20-45 nm.

In phosphate glass the basic unit of structure is the PO₄ tetrahedron. Because phosphate (P) is a pentavalent ion, one oxygen from each tetrahedron remains non-bridging to satisfy charge neutrality of the tetrahedron. Therefore, the connections of PO₄ tetrahedrons are made only at three corners. In this respect, phosphate glass differs from silica-based glasses. Due to the large amount of the non-bridging oxygen, the softening temperature of phosphate glasses is typically lower than silicate glasses. At the same time, the large amount of non-bridging oxygen in phosphate glass offers a great number of sites for rare-earth ions, which results in a high solubility of rare-earth ions. The modifier modifies the glass network, thereby reducing its melting temperature and creating even more sites for rare-earth ions. A uniform distribution of rare-earth ions in the glass is critical to obtain a high gain per unit length. The intermediator bridges some of the bonds in the network thereby increasing the network's strength and chemical durability without raising the melting temperature appreciably.

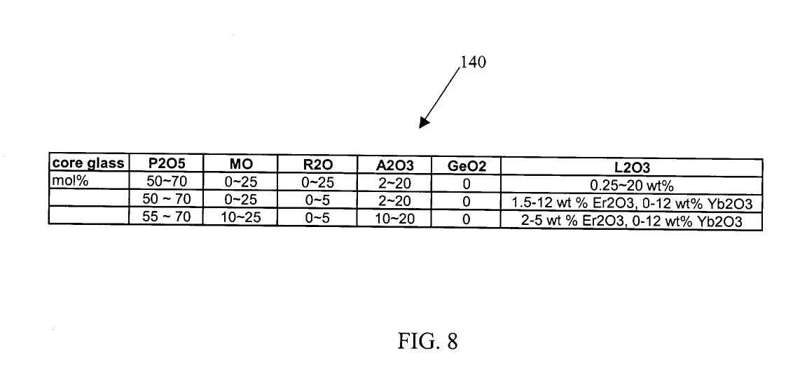

As shown in FIG. 8, the ASE source utilizes a subclass of phosphate glasses 140 that comprises a phosphate (P₂O₅) network former of 50 to 70 mole percent; a network modifier MO of 0 to 25 weight percent (BaO, BeO, MgO, SrO, CaO, ZnO, PbO and mixtures thereof) a network intermediator A₂O₃ of 2 to 20 weight percent (WO₃, Y₂O₃, La₂O₃, Al₂O₃, B₂O₃ and mixtures thereof); and co-doped with erbium 1.5 to 5 weight percent and ytterbium 0 to 12 weight percent. In another embodiment, the phosphate glass 140 comprises a phosphate (P₂O₅) network former of 55 to 70 mole percent; a network modifier MO of 10 to 25 weight percent (BaO, BeO, MgO, SrO, CaO, ZnO, PbO and mixtures thereof) a network intermediator A₂O₃ of 10 to 20 weight percent (WO₃, Y₂O₃, La₂O₃, Al₂O₃, B₂O₃ and mixtures thereof); and co-doped with erbium 2 to 5 weight percent and ytterbium 0 to 12 weight percent.

Er-Doped Tellurite Glasses

Tellurite glass compositions are particularly effective to provide high power ASE sources that produce a broadband signal in the C and L bands. Using a 1W multi-mode pump source and 10-100 cm of doped-phosphate fiber, output power levels of >13 dBm are expected over a bandwidth of 20-70 nm.

In tellurite glass the basic unit of structure is the TeO₄ tetrahedral. TeO₂ is a conditional glass network former. TeO₂ will not form glass on its own, but will do so when melted with one or more suitable oxides, such as PbO, WO₃, ZnO, Al₂O₃, B₂O₃, Y₂O₃, and La₂O₃. Te⁴⁺ ion may occur in three, four or six coordinated structure, which depends on the detailed glass composition and the site of ion. The introduction of B₂O₃, which has a phonon energy up to 1335 cm⁻¹, increases the phonon energy of the host glass and the multiphonon relaxation rate of the ⁴I_{11/2}→⁴I_{13/2} transition, which enhances the population accumulation in the ⁴I_{13/2} level and the 980 nm pumping efficiency. The increased phonon energy also enables the Er:Yb codoping of the tellurite glass discussed above. The inclusion of additional glass components such as Al₂O₃ has been shown to enhance the thermal stability and particularly the chemical durability of the boro-tellurite glasses.

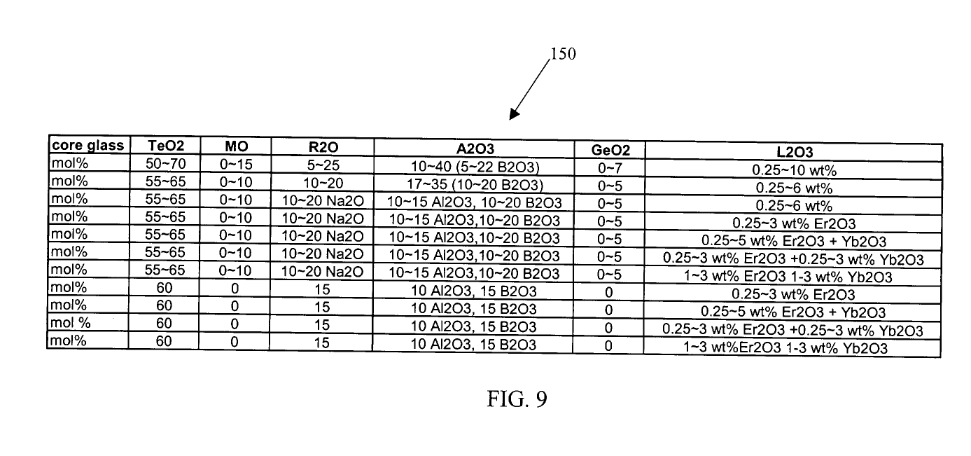

As shown in FIG. 9, one embodiment of the boro-tellurite glass composition 150 for the fiber core includes the following ingredients: a glass network former of tellurite (TeO₂) from 50 to 70 mole percent, a network intermediator A₂O₃ from 10 to 40 mole percent including B₂O₃ from 5 to 22 mole percent (Al₂O₃, Y₂O₃, B₂O₃ and mixtures thereof), a glass network modiier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), Ge0₂ from 0 to 7 mole percent and rare-earth dopant L₂O₃ from 0.25 to 10 weight percent, (Er₂O₃, Yb₂O₃ and mixtures thereof). The cladding glass has a similar composition absent the rare-earth dopants.

In another embodiment, the boro-tellurite glass composition 150 for the fiber core includes the following ingredients: a glass network former TeO₂ from 55 to 65 mole percent, a network intermediator A₂O₃ from 20 to 35 mole percent including B₂O₃ from 10 to 20 mole percent, a glass network modifier R₂O from 10 to 20 mole percent, a glass network modifier MO from 0 to 10 mole percent, Ge0₂ from 0 to 5 mole percent and rare-earth dopant L₂O₃ from 0.25 to 6 weight percent. In one embodiment, the network intermediator A₂O₃ comprises Al₂O₃ from 7 to 15 mole percent and the modifier R₂O comprises Na₂O from 10-20 percent. In another embodiment, the glass comprises intermediator Al₂O₃ from 10 to 15 mole percent. The glass may be doped with, for example, 0.25 to 3 wt. % percent Er₂O₃, 0.25 to 5 wt. % of an Er₂O₃ and Yb₂O₃ mixture, and 0.25 to 5 wt. % each of Er₂O₃ and Yb₂O₃.

Hybrid Phosphate/Tellurite ASE Source

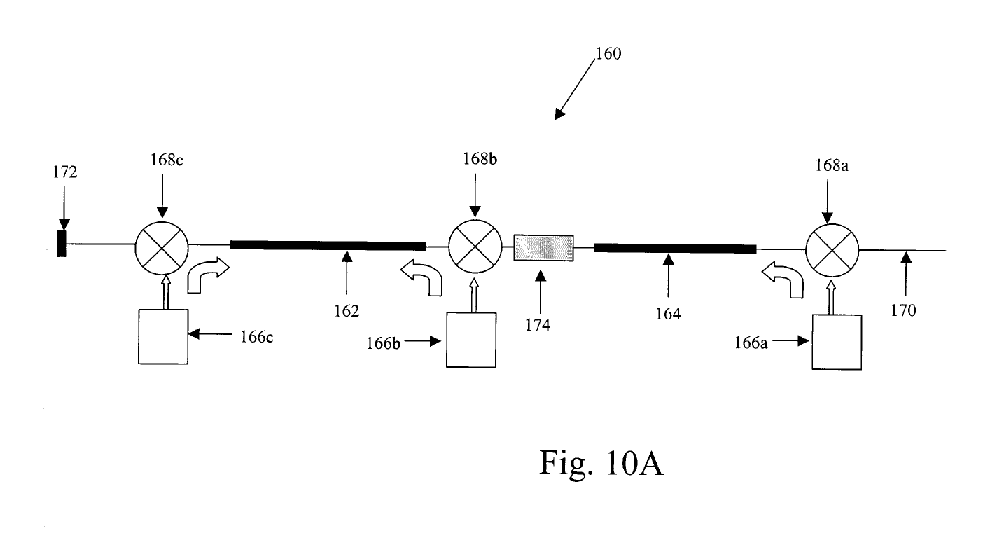

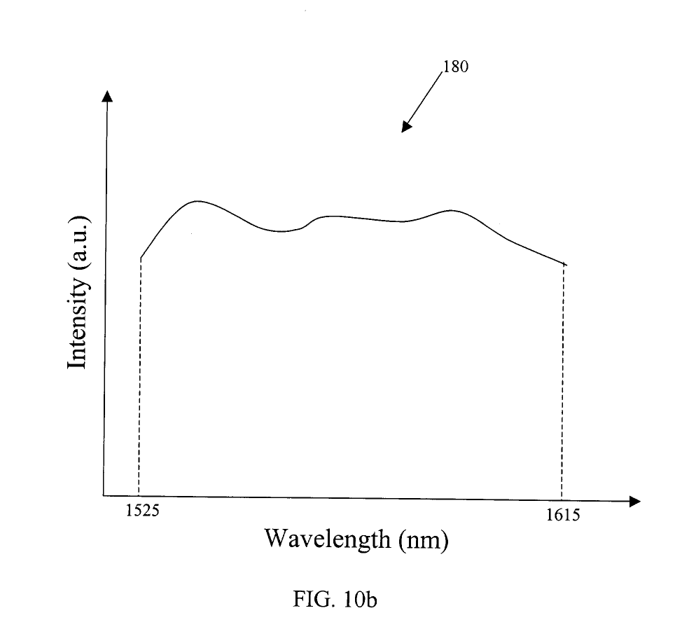

As shown in FIG. 10a, a double-pass backward-signal ASE source 160 includes a length of multi-clad fiber 162 formed from a highly doped phosphate or tellurite glass, a length of multi-clad fiber 164 formed from a highly doped phosphate or tellurite glass, a multi-mode pump source 166a (in one variation 166a and 166b, in another variation 166a and 166c, and in another variation 166a, 166b and 166c), suitably a multimode semiconductor diode laser, and a pump coupler 168a (correspondingly in one variation 168a and 168b, in another variation 168a and 168c, and in another variation 168a, 168b and 168c), and a length of single-mode fiber (SMF) 170. The multimode pump is coupled into and propagates in the fiber cladding where it is absorbed by and excites the rare-earth dopant ions in the fiber core to produce stimulated emission in both the phosphate and boro-tellurite glasses. The superfluorescent source output power is emitted in two directions. One direction of ASE is reflected back from a reflector 172 formed at the end of the fiber, combines with the other direction of ASE and propagates through SMF 170 where it is emitted from the source. An isolator or filter 174 may be inserted between phosphate fiber 162 and tellurite fiber 164 to control spectrum shape. The position of the fibers may be optimized to achieve desirable ASE output shape and power. Multicomponent fiber 162 can be directly connected to 164 in the absence of 166b, 168b and 174.

The emission spectra 180 for the hybrid phosphate/tellurite ASE source is illustrated in FIG. 10b. Such hybrid ASE sources utilize different characteristics of phosphate and tellurite glasses to achieve ultra-broadband emission;

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

We claim:

1. An amplified spontaneous emission (ASE) source, comprising:
An optical fiber having a core, at least one inner cladding and an outer clad, said fiber formed from a multi-component glass host of either phosphate or tellurite with said core doped with at least 0.25 weight percent of a rare-earth dopant; and
A multi-mode pump source that injects optical energy into the fiber's inner cladding to excite the rare-earth dopants in the core and produce stimulated emission of a broadband optical signal.

2. The ASE source of claim 1, wherein said fiber is formed from phosphate (P₂O₅) of 50 to 70 mole percent; MO of 0 to 25 weight percent (BaO, BeO, MgO, SrO, CaO, ZnO, PbO and mixtures thereof), A₂O₃ of 2 to 20 weight percent (WO₃, Y₂O₃, La₂O₃, Al₂O₃, B₂O₃ and mixtures thereof), and doped with 1.5 to 5 weight percent erbium and 0 to 12 weight percent ytterbium.

3. The ASE source of claim 2, wherein said fiber is formed from phosphate (P₂O₅) of 55 to 70 mole percent; MO of 10 to 25 weight percent (BaO, BeO, MgO, SrO, CaO, ZnO, PbO and mixtures thereof), A₂O₃ of 10 to 20 weight percent (WO₃, Y₂O₃, La₂O₃, Al₂O₃, B₂O₃ and mixtures thereof), and doped with 2 to 5 weight percent erbium and 0 to 12 weight percent ytterbium.

4. The ASE source of claim 1, wherein said fiber is formed from tellurite (TeO₂) from 50 to 70 mole percent, A₂O₃ from 10 to 40 mole percent including B₂O₃ from 5 to 22 mole percent (Al2O₃, Y₂O₃, B₂O₃ and mixtures thereof), a glass network modifier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), GeO₂ from 0 to 7 mole percent and rare-earth dopant L₂O₃ from 0.25 to 10 weight percent (Er₂O₃, Yb₂O₃ and mixtures thereof).

5. The ASE source of claim 4, wherein said fiber is formed from tellurite (TeO₂) from 55 to 65 mole percent, A₂O₃ from 20 to 35 mole percent including B₂O₃ from 10 to 20 mole percent and Al₂O₃ from 10 to 15 mole percent, a glass network modifier Na₂O from 10 to 20 mole percent, a glass network modifier MO from 0 to 10 mole percent (MgO, CaO, BaO, ZnO and mixtures thereof), GeO₂ from 0 to 5 mole percent and rare-earth dopant L₂O₃ from 0.25 to 6 weight percent (Er₂O₃, Yb₂O₃ and mixtures thereof).

6. The ASE source of claim 1, wherein the fiber has a length of 10-100 cm.

7. The ASE source of claim 1, further comprising:
A passive fiber having a core and an inner cladding with at least one flat surface, said passive fiber being optically coupled to the optical fiber; and
A total internal reflection (TIR) coupler in optical contact with the inner cladding's flat surface for a length L and having a reflecting surface that forms an angle of taper α with said inner cladding, said TIR coupler being effective to reflect the pump's optical energy at a preselected angle of incidence θ_{inc} for the principal ray and satisfy a TIR condition at its reflecting surface for folding the pump into the passive fiber, wherein said pump beam also satisfies a TIR condition for guiding pump light inside the inner cladding where it is coupled to the optical fiber.

8. The ASE source of claim 1, wherein the optical fiber comprises at least two inner claddings with successively lower indices of refraction.

9. The ASE source of claim 1, further comprising a second optical fiber that is optically pumped by the same multi-mode pump source.

10. An amplified spontaneous emission (ASE) source, comprising:
An optical fiber having a core, at least one inner cladding and an outer clad, said fiber formed from phosphate (P₂O₅) of 50 to 70 mole percent; MO of 0 to 25 weight percent (BaO, BeO, MgO, SrO, CaO, ZnO, PbO and mixtures thereof), A₂O₃ of 2 to 20 weight percent (WO₃, Y₂O₃, La₂O₃, Al₂O₃, B₂O₃ and mixtures thereof), and doped with 1.5 to 5 weight percent erbium and 0 to 12 weight percent ytterbium; and
A multi-mode pump source which injects optical energy into the fiber's inner cladding to excite the rare-earth dopants in the core and produce stimulated emission of a broadband optical signal.

11. The ASE source of claim 10, wherein said fiber is formed from phosphate (P₂O₅) of 55 to 70 mole percent; MO of 10 to 25 weight percent (BaO, BeO, MgO, SrO, CaO, ZnO, PbO and mixtures thereof), A₂O₃ of 10 to 20 weight percent (WO₃, Y₂O₃, La₂O₃, Al₂O₃, B₂O₃ and mixtures thereof), and doped with 2 to 5 weight percent erbium and 0 to 12 weight percent ytterbium.

12. The ASE source of claim 11, wherein said fiber has a length of 10-50 cm.

13. An amplified spontaneous emission (ASE) source, comprising:
An optical fiber having a core, at least one inner cladding and an outer clad, said fiber formed from tellurite (TeO₂) from 50 to 70 mole percent, A₂O₃ from 10 to 40 mole percent including B₂O₃ from 5 to 22 mole percent (Al₂O₃, Y₂O₃, B₂O₃ and mixtures thereof), a glass network modifier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), GeO₂ from 0 to 7 mole percent and rare-earth dopant L₂O₃ from 0.25 to 10 weight percent (Er₂O₃, Yb₂O₃ and mixtures thereof); and
A multi-mode pump source which injects optical energy into the fiber's inner cladding to excite the rare-earth dopants in the core and produce stimulated emission of a broadband optical signal.

14. The ASE source of claim 13, wherein said fiber is formed from tellurite (TeO₂) from 55 to 65 mole percent, A₂O₃ from 20 to 35 mole percent including B₂O₃ from 10 to 20 mole percent and Al₂O₃ from 10 to 15 mole percent, a glass network modifier Na₂O from 10 to 20 mole percent, a glass network modifier MO from 0 to 10 mole percent (MgO, CaO, BaO, ZnO and mixtures thereof), GeO₂ from 0 to 5 mole percent and rare-earth dopant L₂O₃ from 0.25 to 6 weight percent (Er₂O₃, Yb₂O₃ and mixtures thereof).

15. The ASE source of claim 14, wherein the rare-earth dopant comprises 0.25 to 3 weight percent Er₂O₃ and 0.25 to 3 weight percent Yb₂O₃.

16. The ASE source of claim 14, wherein said fiber has a length of 10-100 cm.

17. An amplified spontaneous emission (ASE) source, comprising:
A first optical fiber having a core, at least one inner cladding and an outer clad, said first fiber formed from a phosphate(P₂O₅) glass host with said core doped with at least 0.25 weight percent of a rare-earth dopant;
A second optical fiber having a core, at least one inner cladding and an outer clad, said second fiber formed from a tellurite (TeO₂) glass host with said core doped with at least 0.25 weight percent of a rare-earth dopant; and
A multi-mode pump source which injects optical energy into the fibers' inner claddings to excite the rare-earth dopants in the cores and produce stimulated emission of a broadband optical signal.

18. The ASE source of claim 17, wherein said first optical fiber is formed from phosphate (P₂O₅) of 50 to 70 mole percent; MO of 0 to 25 weight percent (BaO, BeO, MgO, SrO, CaO, ZnO, PbO and mixtures thereof), A₂O₃ of 2 to 20 weight percent (WO₃, Y₂O₃, La₂O₃, Al₂O₃, B₂O₃ and mixtures thereof), and doped with 1.5 to 5 weight percent erbium and 0 to 12 weight percent ytterbium and said second optical fiber is formed from tellurite (TeO₂) from 50 to 70 mole percent, A₂O₃ from 10 to 40 mole percent including B₂O₃ from 5 to 22 mole percent (Al₂O₃, Y₂O₃, B₂O₃ and mixtures thereof), a glass network modifier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), GeO₂ from 0 to 7 mole percent and rare-earth dopant L₂O₃ from 0.25 to 10 weight percent (Er₂O₃, Yb₂O₃ and mixtures thereof).

19. An ASE source of claim 17, wherein said first optical fiber is formed from phosphate (P₂O₅) of 55 to 70 mole percent; MO of 10 to 25 weight percent (BaO, BeO, MgO, SrO, CaO, ZnO, PbO and mixtures thereof), A₂O₃ of 10 to 20 weight percent (WO₃, Y₂O₃, La₂O₃, Al₂O₃, B₂O₃ and mixtures thereof), and doped with 2 to 5 weight percent erbium and 0 to 12 weight percent ytterbium and said second optical fiber is formed from from tellurite (TeO₂) from 55 to 65 mole percent, A₂O₃ from 20 to 35 mole percent including B₂O₃ from 10 to 20 mole percent and Al₂O₃ from 10 to 15 mole percent, a glass network modifier Na₂O from 10 to 20 mole percent, a glass network modifier MO from 0 to 10 mole percent (MgO, CaO, BaO, ZnO and mixtures thereof), GeO₂ from 0 to 5 mole percent and rare-earth dopant L₂O₃ from 0.25 to 6 weight percent (Er₂O₃, Yb₂O₃ and mixtures thereof).

20. The ASE source of claim 17, further comprising an isolator or filter between said first and second optical fibers.

21. An amplified spontaneous emission (ASE) source, comprising:
An outer cladding;
An inner cladding;
a plurality of core elements formed in the inner cladding, each said core element formed from a multi-component glass host of either phosphate or tellurite and doped with at least 0.25 weight percent of a rare-earth dopant; and
A multi-mode pump source which injects optical energy that is confined to the inner cladding to excite the rare-earth dopants in the core elements and produce stimulated emission of a plurality of broadband optical signals

22. The ASE source of claim 21, wherein the multi-mode pump source is positioned to inject optical energy transverse to the orientation of the core elements.

23. The ASE source of claim 21, wherein the multi-mode pump source is positioned to inject optical energy into the ends of the core elements.

24. The ASE source of claim 21, wherein at least one core element is formed from a phosphate glass host and at least one core element is formed from a tellurite glass host.

25. The ASE source of claim 21, wherein core elements formed from a phosphate glass host include phosphate (P₂O₅) of 50 to 70 mole percent; MO of 0 to 25 weight percent (BaO, BeO, MgO, SrO, CaO, ZnO, PbO and mixtures thereof), A₂O₃ of 2 to 20 weight percent (WO₃, Y₂O₃, La₂O₃, Al₂O₃, B₂O₃ and mixtures thereof), and doped with 1.5 to 5 weight percent erbium and 0 to 12 weight percent ytterbium and core elements formed from a tellurite glass host include tellurite (TeO₂) from 50 to 70 mole percent, A₂O₃ from 10 to 40 mole percent including B₂O₃ from 5 to 22 mole percent (Al₂O₃, Y₂O₃, B₂O₃ and mixtures thereof), a glass network modifier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), GeO₂ from 0 to 7 mole percent and rare-earth dopant L₂O₃ from 0.25 to 10 weight percent (Er₂O₃, Yb₂O₃ and mixtures thereof).

26. An amplified spontaneous emission (ASE) source, comprising:
A multi-mode pump source that emits a pump beam;
A passive fiber having a core and an inner cladding with at least one flat surface; and
A total internal reflection (TIR) coupler in optical contact with the inner cladding's flat surface for a length L and having a reflecting surface that forms an angle of taper α with said inner cladding, said TIR coupler being effective to reflect the pump beam at a preselected angle of incidence θ_{inc} for the principal ray and satisfy a TIR condition at its reflecting surface for folding the pump beam into the passive fiber, wherein said pump beam also satisfies a TIR condition for guiding pump light inside the inner cladding; and
An active fiber having a core, at least one inner cladding and an outer clad, said fiber formed from a multi-component glass host of either phosphate or tellurite with said core doped with at least 0.25 weight percent of a rare-earth dopant, said active fiber being optically coupled to said passive fiber to receive said pump beam, which excites the rare-earth dopants in the core to produce stimulated emission of a broadband optical signal.

27. The ASE source of claim 26, wherein said fiber is formed from phosphate (P₂O₅) of 50 to 70 mole percent; MO of 0 to 25 weight percent (BaO, BeO, MgO, SrO, CaO, ZnO, PbO and mixtures thereof), A₂O₃ of 2 to 20 weight percent (WO₃, Y₂O₃, La₂O₃, Al₂O₃, B₂O₃ and mixtures thereof), and doped with 1.5 to 5 weight percent erbium and 0 to 12 weight percent ytterbium.

28. The ASE source of claim 27, wherein said fiber is formed from phosphate (P₂O₅) of 55 to 70 mole percent; MO of 10 to 25 weight percent (BaO, BeO, MgO, SrO, CaO, ZnO, PbO and mixtures thereof), A₂O₃ of 10 to 20 weight percent (WO₃, Y₂O₃, La₂O₃, Al₂O₃, B₂O₃ and mixtures thereof), and doped with 2 to 5 weight percent erbium and 0 to 12 weight percent ytterbium.

29. The ASE source of claim 26, wherein said fiber is formed from tellurite (TeO₂) from 50 to 70 mole percent, A₂O₃ from 10 to 40 mole percent including B₂O₃ from 5 to 22 mole percent (Al₂O₃, Y₂O₃, B₂O₃ and mixtures thereof), a glass network modifier R₂O from 5 to 25 mole percent (Li₂O, Na₂O, K₂O and mixtures thereof), a glass network modifier MO from 0 to 15 mole percent (MgO, CaO, BaO, ZnO and mixtures thereof), GeO₂ from 0 to 7 mole percent and rare-earth dopant L₂O₃ from 0.25 to 10 weight percent (Er₂O₃, Yb₂O₃ and mixtures thereof).

30. The ASE source of claim 29, wherein said fiber is formed from tellurite (TeO₂) from 55 to 65 mole percent, A₂O₃ from 20 to 35 mole percent including B₂O₃ from 10 to 20 mole percent and Al₂O₃ from 10 to 15 mole percent, a glass network modifier Na₂O from 10 to 20 mole percent, a glass network modifier MO from 0 to 10 mole percent (MgO, CaO, BaO, ZnO and mixtures thereof), GeO₂ from 0 to 5 mole percent and rare-earth dopant L₂O₃ from 0.25 to 6 weight percent (Er₂O₃, Yb₂O₃ and mixtures thereof).
